(19) United States
(12) Patent Application Publication
(10) Pub. No.: US 2007/0060322 A1
(43) Pub. Date: Mar. 15, 2007

(54) Method of pari-mutuel wagering in real time

(76) Inventor: Mark Benrus, (US)

Correspondence Address: SKOKOS LAW GROUP, LLC, 1100 JORIE BOULEVARD, SUITE 220, OAK BROOK, IL, 60523, US

(21) Appl. No.: 11/294,976

(22) Filed: Dec. 6, 2005

Related U.S. Application Data
(63) Continuation-in-part of application No. 11/207,657, filed on Aug. 19, 2005.

(51) Int. Cl. G06F 19/00

(52) U.S. Cl. 463/28

(57) ABSTRACT

The present invention is directed to a method of wagering on live horse and dog races or jai alai games, or similar games or races or similar games or races that allow for pari-mutuel wagering on multiple players or runners in real time. The method of wagering includes the steps of an input wager placed by a user, where at least part of the wagering base is at least one real time horse or dog race or jai alai game or similar game or race, specifically a horse or dog race or jai alai game or similar game or race that in real time has yet to start and possesses a start time that falls within a predetermined period of time from the time in which the input wager was placed by the user; the at least one real time horse or dog race or jai alai game is randomly selected from any real time horse or dog races or jai alai games, or similar games or races that fall within the predetermined period of time; a type of wager and then runner (s) for said randomly selected real time horse or dog race or jai alai game are randomly selected which are then correlated to the input wager, the outcome of the randomly selected real time horse or dog races or jai alai games, or similar games or races is identified and a return for the user's wager is identified.

### CROSS REFERENCE TO RELATED APPLICATION

The present application is a continuation-in-part of application Ser. No. 11/207,657 filed on Aug. 19, 2005 by the present applicant.

### BACKGROUND OF THE INVENTION

1. Field of the Invention

This invention relates to the gaming industry and, more particularly, to a method of wagering using real time horse or dog races, jai alai games, or similar games or races that allow for pari-mutuel wagering on multiple players or runners or the like. The invention is also directed to a wagering system of the type through which the inventive wagering method can be practiced.

2. Background of the Invention

The success of the slot machine has had a devastating effect on the live horse and dog racing industry. Slot machines appeal to a much larger audience of bettors because they appeal to all levels of gambling expertise. Beginning bettors at slot machines not only do not need to know the mechanics of a particular game to be successful at wagering, but also do not need to study probabilities to make a calculated wager. To be successful at gambling with slot machines, individuals need only operate a switch through a button or lever, with the results being entirely random and beyond the operator's control. Success at a track, on the other hand, generally requires extensive study of both race forms and race results as well as an intimate understanding of handicapping. The random selection in slot machine gambling obviates the need for understanding handicapping or probabilities. Therefore, in slot machine gambling there is no concept of making a “mistake.” Due to the complete randomness of the results in slot machines, the bettor simply makes a wager and hopes for the best. In addition to the complexity in horse and dog race gambling, there is also the public perception that many track races are “fixed.” Still further, many race tracks have undesirable, antiquated facilities, causing people interested in live races to frequent off-track facilities instead.

To reverse the downward trend at race tracks, it would be desirable to enable gamblers to place wagers on live horse and dog races and jai alai games, or similar games or races, with the ease and convenience of slot machine gambling. While the areas of pari-mutuel wagering and slot machines have been issued several patents, the combination of pari-mutual wagering in real time and slot machines does not have any precedent. For example, U.S. Pat. No. 5,888,136 applies to a method and system of wagering that relies in part on the outcome of a previously run race or game. It is therefore not applicable to a method of wagering on live horse and dog races and jai alai games, or similar games or races in real time.

### SUMMARY OF THE INVENTION

The present invention is directed to a method of wagering on live horse and dog races or jai alai games or similar games or races that allow for pari-mutuel wagering on multiple players or runners, including the steps of an input wager placed by a user, where at least part of the wagering base is at least one real time horse or dog race or jai alai game or similar games or races, specifically a horse or dog race or jai alai game that in real time has yet to start and possesses a start time that falls within a predetermined period of time from the time in which the input wager was placed by the user; the at least one real time horse or dog race or jai alai game is randomly selected from any real time horse or dog races or jai alai games, or similar games or races that fall within the predetermined period of time by assigning a random number to each real time horse or dog race or jai alai game using a random number generator; a type of wager for the randomly selected real time horse or dog race or jai alai game is then randomly selected using a random number generator; using the randomly selected type of wager, the number of runners are then determined in accordance with the number of runners required for the type of wager; a runner or runners for the randomly selected real time horse or dog race or jai alai game are randomly selected using the random number generator; the randomly selected real time horse or dog races or jai alai games, or similar games or races, the randomly selected type of wager and the randomly selected runner or runners (the “randomly selected wagering base”) are correlated to the input wager and become the user's “pending wager;” once the race or game begins, the user's pending wager becomes the user's “in progress wager;” the outcome of the randomly selected real time horse or dog races or jai alai games, or similar games or races is identified; the outcome of the randomly selected real time horse or dog races or jai alai games, or similar games or races is correlated to the user's in progress wager, and a return for the in progress wager is identified.

Through the above method, pari-mutuel wagering can be carried out in a “slot machine” format. Once a pending wager is correlated to the randomly selected real time horse or dog race or jai alai game, the pending wager may be placed into the pari-mutuel pool that is established for that real time horse or dog race or jai alai game, thereby providing for real time pari-mutuel wagering. Likewise, the return for an in progress wager may be paid from the same pool of returns as the pari-mutuel pool that is established for that real time horse or dog race or jai alai game or similar game or race.

The method may further include the steps of providing multiple locations from which input wagers are received and pending wagers are correlated to randomly selected real time horse or dog race or jai alai games, or similar games or races. With this arrangement, it is possible to network the wagering to increase the handle.

The method may further include the steps of providing multiple input wagers to be processed simultaneously from one single location. With this arrangement, a user may make multiple input wagers simultaneously and have multiple pending wagers correlated to various randomly selected real time horse or dog race or jai alai games, or similar games or races to increase the user's chances of winning.

In one embodiment, the input wager may be processed within a terminal whereby a discrete object may be inserted into the terminal by the user. This object may be in the form of a card, bill, coin, ticket, voucher and the like. Alternatively, the input wager may be placed through the use of a prepaid account or credit card whereby the amount of the input wager will be deducted from the balance of such account.

In another embodiment, the input wagering terminal has a repositionable element that is accessible to a user. The discrete object is processed by repositioning the repositionable element after the discrete object is inserted. The repositionable element may be a lever that is pivotable. Alternatively, the input wagering terminal may have push buttons whereby the discrete object may be processed by the depression of the push button by the operator after the discrete object is inserted. The repositioning of the repositionable element or depression of the push button will operate an internal switch that thereby causes the search and random selection of the real time horse or dog races or jai alai games, or similar games or races.

To give the location around the input wagering terminal a more realistic feel, an audio and/or visual signal can be produced to one of a) simulate an equestrian event, b) simulate a live race environment, c) assist placement of input wagers, d) identify the beginning of a wagering period, e) identify the end of a wagering period, f) simulate a live game environment, g) audibly or visually broadcast at least part of the at least one real time horse or dog race or jai alai game and h) simulate standard slot machine sounds and visual signals such as flashing lights.

The method may further include the steps of printing a cash voucher which identifies the results of a winning input wager and has a cash value equivalent to the final return on the winning input wager. The method may further include the steps of printing a ticket indicating each of the user's pending or in progress wagers including the randomly selected real time horse or dog races or jai alai games, or similar games or races, the randomly selected type of wager and the randomly selected runner or runners. This ticket may be printed for real time horse or dog races or jai alai games, or similar games or races that have yet to begin or that are already in progress. Such a ticket may allow the user to leave the input wagering terminal once the user's input wager is processed and becomes the user's pending or in progress wager.

### BRIEF DESCRIPTION OF THE DRAWINGS

FIG. 1 is a flow diagram illustrating a method of pari-mutuel wagering in real time according to the present invention;

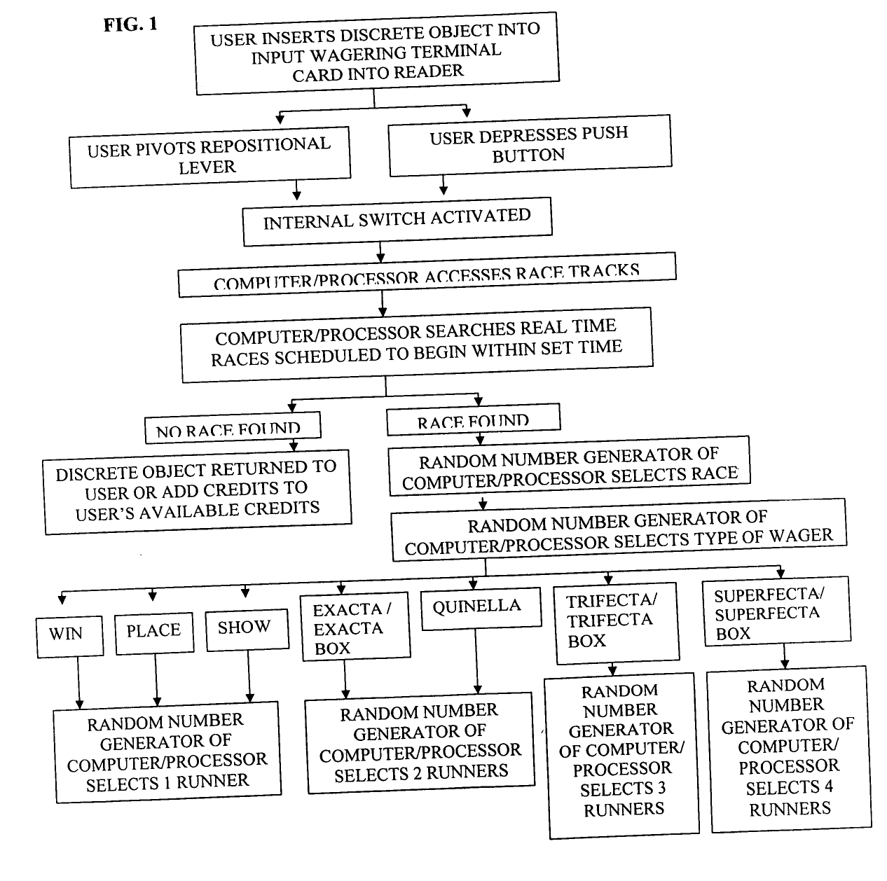

FIG. 2 is a flow diagram illustrating a method of pari-mutuel wagering in real time according to the present invention that is a continuation of the flow diagram presented in FIG. 1;

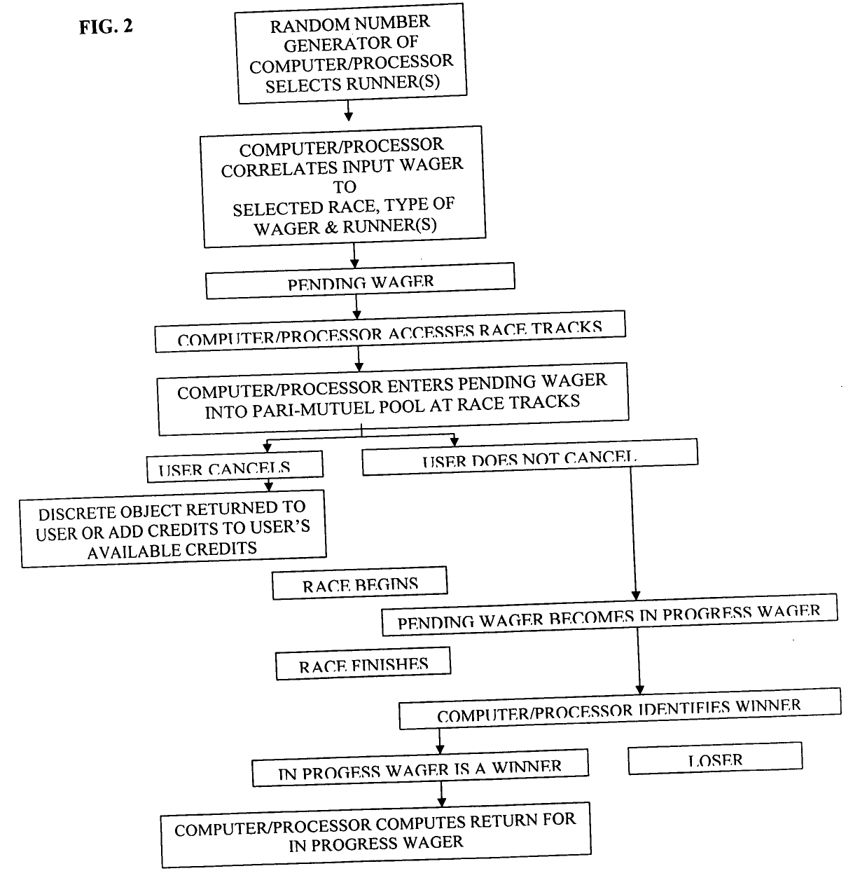

FIG. 3 is an illustration of a system for pari-mutuel wagering in real time according to the present invention; and

FIG. 4 is a front view of an input wagering terminal that is part of the wagering system for pari-mutuel wagering in real time in FIG. 3.

### DETAILED DESCRIPTION OF THE DRAWINGS

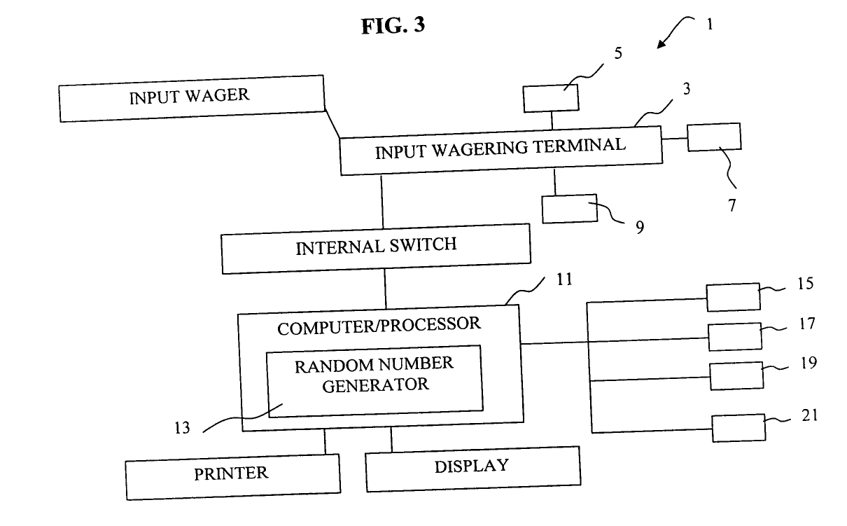

A system of pari-mutuel wagering in real time, according to the present invention, is shown at 1 in FIG. 3. The system consists of at least one input wagering terminal 3, through which a bettor makes a wager. A multitude of terminals, 5, 7, 9 can be linked at the same location, intrastate, interstate and/or internationally.

The invention contemplates that pari-mutuel betting can be carried out in a “slot machine” format.

According to the invention, the system 1 utilizes a processor or computer 11 with a random number generator 13, which has a wagering base made up at least in part by at least one real time live race or a jai alai game or similar game or race. The race may be a horse or dog race or jai alai game, automobile race, or similar game or race or similar game or race that has yet to be run and that allows for pari-mutuel wagering on multiple players or runners or the like.

To make a bet, the user places a discrete object, not shown, which may be in the form of a card, bill, coin, ticket, voucher and the like, into an opening, not shown, in the input wagering terminal 3. Alternatively, the user may use a prepaid account or credit card, not shown, whereby the amount of the input wager will be deducted from the balance of such account. The credit card or prepaid account card may be inserted into a card reader 45. The value of the discrete object or deduction from the prepaid account will be converted into a corresponding value of available credits from which the user can use at the input wagering terminal to place input wagers. Alternatively, the user may use a cash voucher or winning ticket, not shown, and insert such cash voucher or winning ticket into a voucher reader 57 which would be converted to available credits from which the user can place input wagers at the input wagering terminal.

The computer 11 then searches the real time live races or a jai alai games, or similar games or races that are scheduled to begin within a predetermined period of time from the time the user places a discrete object in the input wagering terminal. Advantageously, the computer 11 may be connected via the Internet or via a network to the various race tracks, 15, 17, 19, 21, to determine which races and jai alai games, or similar games or races are about to begin within that predetermined period of time. The random number generator 13 is programmed to assign a random number to each real time live race or a jai alai game that is scheduled to begin within that predetermined period of time. The computer 11 then randomly selects at least one real time live race or game. The computer 11 then randomly selects the type of wager for the real time live race or game by assigning a random number to the type of wagers available, which may include but are not limited to Win, Place, Show, Exacta, Quinella, Trifecta, Superfecta, Exacta Box, Trifecta Box and Superfecta Box.

The computer 11 then determines the number of runners required for this randomly selected type of wager. A Win, Place, or Show type of wager requires a selection of a single runner because the computer 11 is randomly selecting whether a selected runner will be the winner of such race, place in the top two runners of such race, or make a showing in the top three runners of such race, respectively. If a Win, Place or Show type of wager is randomly selected by the computer 11, a single runner will be randomly selected by the computer processor 11. An Exacta, Quinella or Exacta Box type of wager requires a selection of two runners because the computer is selecting the top two finishers of the race. If the type of wager randomly selected by the computer processor 11 is an Exacta, Quinella, or Exacta Box, two runners will be randomly selected by the computer 11. A Trifecta or Trifecta Box type of wager requires a selection of three runners because the computer is selecting the top three finishers of the race. If the type of wager randomly selected by the computer processor 11 is a Trifecta or Trifecta Box, three runners will be randomly selected by the computer 11. A Superfecta or Superfecta Box type of wager requires a selection of four runners because the computer is selecting the top four finishers of the race. If the type of wager randomly selected by the computer processor 11 is a Superfecta or Superfecta Box, four runners will be randomly selected by the computer 11. Therefore, the type of wager randomly selected by the computer 11 will also determine the number of runners required for such a type of wager. The computer 11 then randomly selects the runner(s) for the randomly selected real time live race or game and randomly selected type of wager.

The computer 11 then correlates the randomly selected real time live race or game, the randomly selected type of wager, and the randomly selected runner(s) to the user's input wager to thereby create what may be called the user's “pending wager.” The computer 11 thereafter enters the pending wager into the pari-mutuel pool that is established for the randomly selected real time horse or dog race or jai alai game or similar game or race. The pari-mutuel pools are established at the various race tracks, 15, 17, 19, and 21 from which the real time live races were randomly selected. Advantageously, the computer 11 may be connected via the Internet or via a network to the various race tracks, 15, 17, 19, and 21 to enter the pending wagers into such established pari-mutuel pools.

Once the randomly selected race of the user's pending wager begins in real time at the race track, the user's pending wager is transformed into what may be called the user's “in progress wager.” Advantageously, the computer 11 will deem a user's pending wager an in progress wager when the randomly selected race or game of the user's pending wager is within a set period of time from the start time of such race. Once the real time live race is finished, the computer 11 determines whether the randomly selected runner is a “winner” according to the outcome of such real time live race, terminating the in progress wager.

In this embodiment, the computer 11 randomly selects the type of wager for the user. The type of input wager may be any type of wager a user would be able to choose at a live race track, including but not limited to: Win, Place, Show, Exacta, Quinella, Trifecta, Superfecta, Exacta Box, Trifecta Box and Superfecta Box. By allowing the computer 11 to randomly select the type of wager, the confusion relating to determining which type of wager has the best returns for the user is eliminated. When the real time live race is finished, the computer 11 determines whether the randomly selected runner is a “winner;” and if the selected runner is a “winner”, the computer then determines what the payoff is for the in progress wager. Since the in progress wager is entered into the pari-mutuel pool that is established for that real time horse or dog race or jai alai game or similar game or race, the payoff for each in progress wager must be determined in proportion to the amount of the input wager. In this embodiment, the payoff for a “winning” wager would be equivalent to the payoff at the pari-mutuel pool but scaled back in proportion to the value of the input wager.

In another embodiment of the invention, the user would be allowed to override the predetermined period of time to allow for a greater predetermined period of time in which real time live races or games can be selected. In the event that there is no real time live race or game from which to select within that predetermined period of time from the time the user places an input wager, the input wagering terminal 3 would return the discrete object to the user or add the amount of the input wager to an internally maintained record of the user's available credits. Advantageously, the input wagering terminal 3 would produce the same audio and visual signals as if the user was a “winner” to add to the excitement of the wagering experience.

In yet another embodiment, the user can be permitted to select at least one number that the computer 11 would use when randomly selecting the runner(s) such that the at least one number selected by the user must appear in at least one of the runner or other participant numbers selected. If the user selected the number 6 in a horse race, for example, then at least one of the horses randomly selected by the computer would have the running number 6. Such a selection by the user would allow the user to play his or her “favorite” number or numbers. If the user selected the numbers 6 and 21, at least one of the runners randomly selected by the computer 11 would have the running number 6 and at least one of the runners randomly selected by the computer 11 would have the running number 21.

In an alternative embodiment, the user can choose whether the runner that is deemed to be a favorite in the real time live race at the time the computer 11 makes the random selection would be included or excluded from the runner(s) that are randomly selected by the computer 11. Such a choice by the user would be made prior to the random selection of the real time live race or game by the computer 11.

In one embodiment of the invention, the input wagering terminal 3 may be any personal computer or computing device that is linked to the computer 11 and to the random number generator 13 via the Internet. The user thereby can use his or her own personal computer to link to a host computer or server via a network of some type such as the Internet and is allowed to place input wagers from the comfort of his or her home. The computer 11 may be linked to the various race tracks, 15, 17, 19, and 21 via the Internet or via a network to determine which races and jai alai games, or similar games or races are about to begin with a predetermined period of time. The user may use a credit card or prepaid account card to place an input wager, whereby the amount of the input wager will be deducted from the balance of such account. The computer 11 may process the input wager and then take the identical steps as described above to create the user's pending and in progress wagers. The user may also be able to use any hand-held wireless devices such as personal digital assistants (PDA) and cellular phones and any other hand held wireless devices that allow Internet access, to link to the computer 11 via a network of some type such as the Internet to place input wagers. Those of skill in the art will understand that the present invention can be deployed on most any device now available or hereafter developed that allows users to access the Internet.

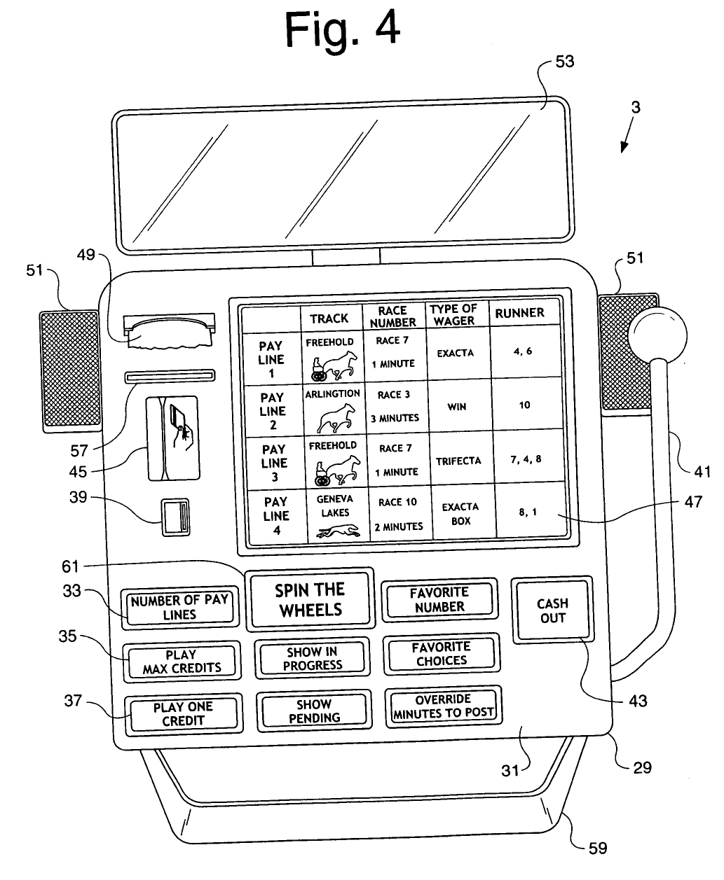

In one embodiment of the invention, the input wagering terminal 3, as shown in FIG. 4, includes a housing 29 which simulates the appearance of a conventional slot machine. The housing has a front display wall 31 with push or slide button operators. The push or slide button operators 33, 35, 37, may allow the user to select how many credits or the amount of money the user would like to place for each input wager.

The housing has a slot or opening for a coin 39 or other token that is processed to accept the user's input wager. After inputting the coin or other token and the computer 11 has converted the coin or discrete object into a corresponding value of available credits, a repositionable lever 41, in this case a pivotable operating arm as used on slot machines, is pivoted to operate an internal switch, not shown, which thereby causes the random number generator 13 of the computer 11 to search the real time live races or jai alai games or similar games or races that are scheduled to begin within a predetermined period of time. Alternatively, the repositional lever may be replaced with a push button allowing the operator to depress the button 61 to cause the random number generator of the computer 11 to search the real time live races or jai alai games, or similar games or races that are scheduled to begin within a predetermined period of time. As an alternative to a coin actuator, a reader or scanner 45 could be used to identify information on a card to initiate the acceptance of the user's input wager. Such a reader or scanner 45 may be used to identify information on a credit card or card issued by the facility that may function similarly to a debit card issued by a financial institution and to which a user can add money. Alternatively, a voucher reader 57 may be used to identify information on a cash voucher that has a cash value which can be converted to available credits from which a user may place input wagers at the input wagering terminal.

In one embodiment, the housing 29 may have a display 47 that identifies to the user the pending wagers, including but not limited to the following information: the race track or the game location, the specific race or game selected, the type of wager selected, and the runner(s) randomly selected by the computer 11. Advantageously, the user may be given the option to cancel one of the pending wagers prior to the start of the live race or game. In the event a user cancels such a pending wager prior to the start of the live race or game, the input wagering terminal 3 would return the coins or the discrete object to the user or add the amount of the input wager to the available credits to the user.

In one embodiment, a user may be able to place multiple input wagers simultaneously at a single input wagering terminal. For each input wager, the computer 11 randomly selects a real time live race or game, a type of wager, and runner(s) and correlates such selections to the input wager to become individual pending wagers. Each pending wager then may be shown on the display 47 of the input wagering terminal 3 as a separate “pay line.” The user may also select the number of input wagers to be placed by depressing a button 33 on the front display wall 31 of the input wagering terminal.

In one embodiment, a user may be able to place a single input wager on each of a series of real time live races or games. The computer 11 may be programmed to randomly select a real time live race or game, a type of wager, and (a) runner(s) for two or more real live time races or games which are then grouped together to form a single input wager. The outcomes of all of these real time live races or games which together form a single input wager must be identified to determine if the input wager is a “winner.” In this embodiment, the system functions in a manner similar to the way in which a user would place a wager on a “Daily Double,” “Pick 3,” “Pick 4,” or “Pick 9” at an actual racing track facility. Advantageously, the user can select “Daily Double,” “Pick 3,” “Pick 4,” or “Pick 9” after placing a single input wager. The computer 11 responds by automatically taking the steps discussed above to randomly select a race, type of wager and runner(s) for each of several real time, live races or games. Advantageously, the user may be able to leave the input wagering terminal 3 once the user's input wager is entered and processed by having the input wagering terminal 3 issue a ticket indicating each of the user's pending or in progress wagers, including: the randomly selected real time horse or dog races or jai alai games or similar games or races, the randomly selected types of wagers, and the randomly selected runners or players.

In one embodiment, the housing may also have a printer 49 that can print a cash voucher which identifies the results of a winning input wager and has a cash value equivalent to the final return on the winning input wager. The printer 49 may also print a ticket (not shown) indicating each of the user's pending or in progress wagers including the randomly selected real time horse or dog races or jai alai games or similar games or races, the randomly selected type of wager, and the randomly selected runner or runners. The ticket may be printed for real time horse or dog races or jai alai games, or similar games or races that have yet to begin or that are already in progress. Such a ticket permits the user to leave the input wagering terminal. Once the outcome of the user's in progress wagers are determined, if one or more of the user's in progress wager are “winners,” the user may use the printed ticket to redeem the user's return or payoff on the in progress wagers from the facility. The printer 49 may also print a voucher or ticket indicating the user's previously-made wagers.

To add another dimension to the system, an audio signal generator 51 and/or a visual image generator 53 can be used to produce effects that can: simulate an equestrian event, a live race or game environment, or a standard slot machine environment; that can assist with the placement of input wagers; that can identify the beginning and the end of a wagering period; and that can in other ways add to the excitement or authenticity of the gaming experience. The randomly selected, real time live race may be broadcast in real time audibly and/or visually through the system, with the actual race shown on the display 47. Advantageously, the user may able to select the race that has been randomly selected by the computer 11 to be received in real time over an Internet connection or other form of direct feed. Alternatively, the display 47 may be connected to the Internet or direct feed such that the real time live race of the user's pending or in progress wager may be broadcast from the display 47. Advantageously, the user may be able to depress a button located on the front display wall 31 that would be connected to a switch, not shown, that would allow the user to select between a live broadcast of the real time live races or games of the user's pending or in progress wagers.

In one embodiment of the invention, the user is able to “cash out” all of the user's available credits by depressing a button 43 located on the front display wall 31. When the button 43 is depressed, the user is given the option of having the input wagering terminal 3: (1) Return the user's available credits in the form of a discrete object or objects, such as one or more coins dropped into a coin receptacle 59; (2) Print a cash voucher which has a cash value equal to the value of the user's available credits from the printer 49; (3) Print a voucher or ticket indicating the user's pending or in progress wagers from the printer 49; (4) Cancel all of the user's pending wagers; and (5) any reasonable combination of the actions (1)-(4).

In one embodiment of the invention, a multitude of terminals are linked together either at one location, or within a single state, or throughout a single country, or even internationally. By networking the terminals together, it is then possible to permit additional wagers to be made between such terminals such as “Bonus Spins” whereby users would be eligible for additional payoffs based upon the input wagers placed at the linked terminals. The terminals may be networked together within the same location, where additional wagers may be made between the networked terminals as in conventional slot machine gambling where users are given the chance to gamble on bonus spins that are termed, “Wheel of Fortune.” Such additional wagers are not entered into the pari-mutuel pools established at the various race tracks 15, 17, 19 and 21 but rather are pools that are set up at each location or networked locations.

In one embodiment, the computer 11 may be connected via the Internet or via a network to the various race tracks, 15, 17, 19, and 21. The computer 11 may be linked to the various race tracks 15, 17, 19, and 21, through a communication system. The communication system may include a central processing unit that can access and configure the information regarding the real time live races or games at the various race tracks 15, 17, 19, and 21. It may also include a transceiver that can communicate with the input wagering terminal 3 and the central processing unit.

In one embodiment of the invention, the user can optionally override the random selection of the real time live race or game by the computer 11 and select the real time live race or game that is scheduled to run in a race track nearest to the physical location of the input wagering terminal 3. Alternatively, during the random selection of the real time live race or game, the computer 11 may be programmed to place a heavier weight on the selection of the real time live race or game nearest to the physical location of the input wagering terminal 3.

In one embodiment of the invention, the user can optionally override the random selection of the type of wager placed by the computer 11 and select any type of wager that may be placed on the real time live race or game, such as Win, Place or Show. Alternatively, during the random selection of the type of wager, the computer 11 may be programmed to place a heavier weight on the selection of the type of wagers of a single runner such as Win, Place and Show. The type of wagers Win, Place and Show have a greater likelihood of being a “winning” wager given that the user is only wagering on the outcome of a single runner as opposed to multiple runners. Therefore, by placing a greater weight on the Win, Place and Show types of wagers, the user has a greater likelihood of making a “winning” wager.

In one embodiment of the invention, the user may be able to override the number of runners randomly selected by the computer 11 in a boxed set. For example, for an Exacta Box type of wager, the computer 11 randomly selects two runners because the computer is selecting the top two finishers of the race. The user may override the selection of two runners for an Exacta Box type of wager by increasing the number of runners selected for an Exacta Box type of wager. The user may select as many runners as desired to finish as the top two finishers of the race. As another example, for a Trifecta Box type of wager, the computer 11 randomly selects three runners because the computer is selecting the top three finishers of the race. The user may override the selection of three runners for a Trifecta Box type of wager by increasing the number of runners selected for a Trifecta Box type of wager. The user may select as many runners as desired to finish as the top three finishers of the race. As a further example, for a Superfecta Box type of wager, the computer 11 randomly selects four runners because the computer is selecting the top four finishers of the race. The user may override the selection of four runners for a Superfecta Box type of wager by increasing the number of runners selected for a Superfecta Box type of wager. The user may select as many runners as desired to finish as the top four finishers of the race.

In one embodiment of the invention, the computer 11 may be programmed to employ runner selection algorithms in the selection of runners. The runner selection algorithms may use handicapping information to identify a set of runners. The algorithm analyzes for each runner the handicapping information including without limitation the runner's statistics, runner's jockey statistics, the track condition of the race, and the times between races for the runner. Further the algorithm analyzes for each runner the odds information for the race.

In one embodiment of the invention, the computer 11 is programmed to cause marketing and advertising promotion video segments to appear on the display 47 of the input wagering terminal 3. The marketing and advertising promotion video segments may include pre-recorded video advertisements, in-video ticker-tape crawl, video banners, pre-recorded interviews concerning the advertised product or services, and short films concerning the advertised product or services. Such marketing and advertising promotion video segments may be fed into the input wagering terminal 3 via an Internet connection or direct feed. Alternatively, the advertisements and marketing promotions may be integrated via conventional Internet advertising means including banners and pop up windows.

In one embodiment of the invention, the input wagering terminal 3 is also designed to provide conventional slot machine wagering, including for example the games slots, video poker, video blackjack, Caribbean stud, and Texas Hold'em. The input wagering terminal 3 then allows the user to switch between placing wagers on real time live races and games on the one hand and placing wagers on conventional wagering games such as those just listed on the other hand. By providing the user with traditional types of slot machine gambling, the user can avoid any “down time” in gambling that might otherwise cause the user to become bored and walk away from the input wagering terminal 3. The system could be arranged so that the user can switch between placing wagers on live action races and placing wagers on conventional slot machine wagering games by simply depressing a button on the front display wall 31 of the input wagering terminal 3.

In one embodiment of the present invention, the user can increase the wager amount for each pending wager once that pending wager has been created by the computer 11. The user may increase the wager for a pending wager by: by increasing the amount of available credits to be placed on the pending wager; by depositing a coin 39 or other token into the slot or opening; by inputting a credit card or card issued by the facility that may function similarly to a debit card issued by a financial institution into the reader or scanner 45, or; by inputting a cash voucher into the voucher reader 57. The system could be arranged so that the user can increase the wager for a pending wager by simply depressing a button on the front display wall 31 of the input wagering terminal 3.

The present invention may further be directed to a method of wagering on automobile racing, including the steps of an input wager placed by a user, where at least part of the wagering base is at least one real time automobile race. The at least one real time automobile race is randomly selected; then a type of wager for the automobile race is randomly selected; and finally the number of a racing automobile (or of several racing automobiles) is (or are) then randomly determined in accordance with the number of racing automobiles required for the type of wager selected, These randomly-selected wager elements which may be collectively referred to as “the “randomly selected wagering base,” are then combined to form the input wager and to become the user's “pending wager,” Once the race actually begins, the user's pending wager becomes the user's “in progress wager.” After the race, the outcome of the randomly-selected, real time automobile race is identified and is correlated with the user's in progress wager, and a return for the in progress wager is then identified.

The foregoing disclosure has been set forth to illustrate the invention and is not intended to be limiting. Alternative modifications of the disclosed embodiments incorporating the spirit and substance of the invention will occur to persons skilled in the art, and accordingly the invention should be construed to include everything that falls within the scope of the appended claims and equivalents thereof.

What is claimed is:

1. A method of pari-mutuel wagering in real time comprising the steps of:
a. Receiving an input wager from a user;
b. Directing the input wager to a random number generator;
c. Randomly selecting at least one real time horse or dog race or jai alai game or similar game or race that has yet to begin for said input wager;
d. Randomly selecting the type of wager for said real time horse or dog race or jai alai game or similar game or race for said input wager;
e. Randomly selecting the runners for said real time horse or dog race or jai alai game or similar game or race for said input wager;
f. Assigning said randomly selected real time horse or dog race or jai alai game or similar game or race, type of wager and runners to said input wager to become user's pending wager wherein said pending wager becomes an in progress wager upon the start of said real time horse or dog race or jai alai game or similar game or race;
g. Identifying outcome of said real time horse or dog race or jai alai game or similar game or race; and
h. Identifying return for said in progress wager based on outcome of said real time horse or dog race or jai alai game or similar game or race.

2. The method of wagering according to claim 1, wherein the type of wager randomly selected is a conventional type of wager placed at race tracks.

3. The method of wagering according to claim 1, wherein the type of wager randomly selected is a conventional boxed type of wager placed at race tracks.

4. The method of wagering according to claim 3 including the steps of identifying a money value for each input wager.

5. The method of wagering according to claim 4 including the steps of assigning an amount of credits to the user corresponding to said money value for each input wager.

6. The method of wagering according to claim 5 including the step of identifying a final return amount for each in progress wager.

7. The method of wagering according to claim 6 including the step of providing a final return amount for each in progress wager in an amount of credits to the user.

8. The method of wagering according to claim 7 including the step of providing a money value for the amount of credits corresponding to said final return amount.

9. The method of wagering according to claim 8, wherein the amount of an input wager may be increased once a pending wager has been created.

10. The method of wagering according to claim 1 including the steps of providing a network to race tracks having real time horse or dog race or jai alai games, or similar games or races and established pari-mutuel betting pools.

11. The method of wagering according to claim 10 including the steps of entering said in progress wager into the pari-mutuel pool that is established for said real time horse or dog race or jai alai game, or similar games or races.

12. The method of wagering according to claim 11 including the steps of identifying the return for said in progress wager determined by the pari-mutuel pool that is established for said real time horse or dog race or jai alai game, or similar games or races.

13. The method of wagering according to claim 12 wherein the input wager in step (a) may be received from any computing device linked to a host computer or server via the Internet.

14. The method of wagering according to claim 12 wherein the input wager in step (a) may be received from any handheld device linked to a host computer or server via the Internet.

15. The method of wagering according to claim 1 including the steps of providing multiple locations from which input wagers are received and correlated to randomly selected real time live horse or dog race or jai alai games, or similar games or races.

16. The method of wagering according to claim 1 wherein the steps (b)-(h) can be executed simultaneously so that a user may be able to place multiple input wagers simultaneously at a single input wagering terminal.

17. The method of wagering according to claim 1 wherein the steps (b)-(h) can be executed for at least two real time live races or games from a single input wager.

18. The method of wagering according to claim 1 including the step of printing a voucher which identifies the results of a winning input wager and has a cash value equivalent to the return on said winning input wager.

19. The method of wagering according to claim 1 including the steps of printing a ticket indicating each of the user's pending or in progress wagers including the randomly selected real time horse or dog races or jai alai games, or similar games or races, the randomly selected type of wager and the randomly selected runner or runners.

20. The method of wagering according to claim 1 including the steps of providing an input wagering terminal and processing a discrete object that is inserted into the input wagering terminal to commence the random number generator.

21. The method of wagering according to claim 20 wherein the input wagering terminal has a repositionable element that is accessible to a user and the step of processing a discrete object comprises the step of repositioning the repositionable element after the discrete object is inserted into the input wagering terminal.

22. The method of wagering according to claim 20 wherein the input wagering terminal includes a push button that is accessible to a user and the step of processing a discrete object comprises the step of depressing the push button after the discrete object is inserted into the input wagering terminal.

23. The method of wagering according to claim 20 wherein the input wagering terminal provides for conventional slot machine type of wagering.

24. The method of wagering according to claim 20 wherein said input wagering terminal is a computing device linked to a host computer or server via the Internet to provide a network to race tracks having real time horse or dog race or jai alai games, or similar games or races and established pari-mutuel betting pools to enter said in progress wager into the pari-mutuel pool that is established for said real time horse or dog race or jai alai game and identify the return for said in progress wager determined by said pari-mutuel pool once the outcome of said real time horse or dog race or jai alai game is identified.

25. The method of wagering according to claim 20 wherein said input wagering terminal is a handheld device linked to a host computer or server via the Internet to provide a network to race tracks having real time horse or dog race or jai alai games, or similar games or races and established pari-mutuel betting pools to enter said in progress wager into the pari-mutuel pool that is established for said real time horse or dog race or jai alai game and identify the return for said in progress wager determined by said pari-mutuel pool once the outcome of said real time horse or dog race or jai alai game is identified.

26. The method of wagering according to claim 20 wherein said input wagering terminal is a handheld device linked to a computer via the Internet to provide a network to race tracks having real time horse or dog race or jai alai games, or similar games or races and established pari-mutuel betting pools to enter said in progress wager into the pari-mutuel pool that is established for said real time horse or dog race or jai alai game and identify the return for said in progress wager determined by said pari-mutuel pool once the outcome of said real time horse or dog race or jai alai game is identified.

27. The method of wagering according to claim 20 wherein said input wagering terminal includes a display that identifies the user's pending or in progress wagers, including the race track, race, type of wager and runners that have been randomly selected.

28. The method of wagering according to claim 20, wherein marketing and advertising promotion video segments may be programmed to appear on the display.

29. The method of wagering according to claim 20 including the steps of providing an input wagering terminal and at the input wagering terminal producing at least one of an audio and visual signal to at least one of a) simulate an equestrian event, b) broadcast a live race environment, c) simulate a standard slot machine environment, d) assist placement of input wagers, d) identify the beginning of a wagering period, e) identify the end of a wagering period, and f) simulate a live game environment.

30. The method of wagering according to claim 29 wherein said input wagering terminal broadcasts in real time the live horse or dog race or jai alai games, or similar games or races of the user's in progress wager.

31. The method of wagering according to claim 20 including the steps of providing at least two input wagering terminals that are linked.

32. The method of wagering according to claim 31 wherein wagers may be placed between such terminals.

33. The method of wagering according to claim 1, wherein the user selects whether the runner that is deemed to be a favorite in the real time live race or game would be included or excluded from the runners to be randomly selected.

34. The method of wagering according to claim 1, wherein the user selects a number that would be used when randomly selecting the runner such that the number selected by the user must be appear at least in one of the runner numbers selected.

35. The method of wagering according to claim 1, wherein the random selection of the type of wager is overridden to select any type of wager.

36. The method of wagering according to claim 1, wherein the number of runners randomly selected by the computer in a boxed set is overridden to select any number of runners for a boxed set of runners.

37. The method of wagering according to claim 1, wherein runner selection algorithms are used in the selection of runners.

38. The method of wagering according to claim 1, wherein the real time horse or dog race or jai alai game or similar game or race is to be randomly selected in a predetermined period of time from which the input wager is received.

39. The method of wagering according to claim 38, wherein user is allowed to override said predetermined period of time to allow for a greater period of time.

40. The method of wagering according to claim 38, wherein if no real time horse or dog race or jai alai game or similar game or race has a start time within said predetermined period of time, user's input wager is returned to user.

41. The method of wagering according to claim 1, wherein the real time live race or game that is scheduled to run in a race track nearest to the physical location of the input wagering terminal is selected.

42. A method of wagering according to claim 1, wherein the real time live race or game is an automobile race.

43. A wagering system comprising:
at least one input wagering terminal through which a user places an input wager;
a computer or processor with a random number generator that is linked to said input wagering where said computer or processor is networked to race tracks having real time horse or dog race or jai alai games, or similar games or races and established pari-mutuel betting pools and where said computer or processor is programmed to randomly select a real time horse or dog race or jai alai games, or similar games or races, assign said input wager to said real time horse or dog race or jai alai games, or similar games or races, identify outcome of said real time horse or dog race or jai alai game or similar game or race, and identify a return for said input wager.

44. The wagering system according to claim 43 wherein said input wagering terminal can process a discrete object that is inserted into the input wagering terminal to process the input wager.

45. The wagering system according to claim 43 wherein the input wagering terminal has a repositionable element that is accessible to a user which is pivoted to commence the random selection by the random number generator.

46. The wagering system according to claim 43 wherein the input wagering terminal includes a push button that is accessible to a user which is depressed to cause the random number generator to commence.

47. The wagering system according to claim 43 wherein said input wagering terminal is a computing device linked to a host computer or server via the Internet to provide a network to race tracks having real time horse or dog race or jai alai games, or similar games or races and established pari-mutuel betting pools to enter said in progress wager into the pari-mutuel pool that is established for said real time horse or dog race or jai alai game and identify the return for said in progress wager determined by said pari-mutuel pool once the outcome of said real time horse or dog race or jai alai game is identified.

48. The wagering system according to claim 43 wherein said input wagering terminal is a handheld device linked to a host computer or server via the Internet to provide a network to race tracks having real time horse or dog race or jai alai garnes, or similar games or races and established pari-mutuel betting pools to enter said in progress wager into the pari-mutuel pool that is established for said real time horse or dog race or jai alai game and identify the return for said in progress wager determined by said pari-mutuel pool once the outcome of said real time horse or dog race or jai alai game is identified.

49. The wagering system according to claim 43 wherein said input wagering terminal includes a display that identifies the user's pending or in progress wagers, including the race track, race, type of wager and runners that have been randomly selected.

50. The wagering system according to claim 43 wherein the input wagering terminal includes audio and visual signal generators producing at least one of an audio and visual signals to at least one of a) simulate an equestrian event, b) broadcast a live race environment, c) simulate a standard slot machine environment, d) assist placement of input wagers, d) identify the beginning of a wagering period, e) identify the end of a wagering period, and f) simulate a live game environment.
